(19) United States
(12) Patent Application Publication
(10) Pub. No.: US 2026/0210883 A1
(43) Pub. Date: Jul. 23, 2026

(54) PROCESSING METHOD AND SYSTEM FOR THREE-DIMENSIONAL NEUTRON DIFFRACTION DATA OF SINGLE CRYSTAL MATERIAL

(71) Applicant: Shanghai Jiao Tong University, Shanghai (CN)

(72) Inventors: Shengyi ZHONG, Shanghai (CN); Pucong SHENG, Shanghai (CN); Hao LIN, Shanghai (CN); Jiachen LONG, Shanghai (CN)

(73) Assignee: Shanghai Jiao Tong University, Shanghai (CN)

(21) Appl. No.: 19/461,552

(22) Filed: Jan. 27, 2026

(30) Foreign Application Priority Data
Apr. 7, 2025 (CN) 202510426664.2

(51) Int. Cl. G01N 23/207

(52) U.S. Cl. CPC G01N 23/2073; G01N 2223/604

(57) ABSTRACT

A processing method and system for three-dimensional neutron diffraction data of single crystal material are provided, the method includes: performing a coarse scan on a single crystal sample in a pole-figure mode to determine a rotation center of a single crystal sample signal; performing a fine scan at the rotation center to obtain a three-dimensional neutron diffraction signal; decomposing the three-dimensional neutron diffraction signal to obtain a diffraction peak curve and a rocking curve plane; correcting coordinates of the rocking curve plane; decomposing a corrected rocking curve plane to obtain a rocking curve; and quantitatively analyzing a lattice constant and orientation distribution information in the three-dimensional neutron diffraction signal according to the diffraction peak curve and the rocking curve.

### CROSS-REFERENCE TO RELATED APPLICATIONS

This application claims priority of Chinese Patent Application No. 202510426664.2, filed on Apr. 7, 2025, the content of which is hereby incorporated by reference.

### TECHNICAL FIELD

The disclosure relates to the technical field of diffraction data processing, and in particular to a processing method and system for three-dimensional neutron diffraction data of single crystal material.

### BACKGROUND

Neutron diffraction, as a nondestructive characterization technique, is widely used in the study of single crystal materials. The existing neutron diffraction experiments mainly collect and analyze single diffraction data by fixing Euler angle and using two-dimensional area detector.

In the literature (in-s itu neutron diffraction during stress relaxation of a single crystal nickel-base superalloy [j]. Scripta Materialia, 2017, 131:103-107. Collins D M, D′ souza N, Panwisawas C.), the lattice constant of nickel-based single crystal superalloy is analyzed by processing the two-dimensional diffraction data. However, this method may only prosess the signal of single orientation direction, and fails to consider the influence of multiple orientation directions on the overall crystal structure.

In the literature (a neutron diffraction study of lattice distortion, mi smatch and mi sorientation in a single-crystal superalloy after different heat treatments. Acta materialia. 2013; 61 (7): 2308-19. Wu E, Sun G, Chen B, Pirling T, Hughes D J, Wang S, et al.), by analyzing the two-dimensional detector signals, the orientation information of single crystal materials is obtained. However, due to the limitations of the two-dimensional area detector, the method may only capture the orientation information in a single direction, and may not achieve a comprehensive analysis of the crystal complete orientation distribution.

### SUMMARY

Aiming at the defects in the prior art, the disclosure provides a processing method and system for three-dimensional neutron diffraction data of single crystal material.

The disclosure provides a processing method for three-dimensional neutron diffraction data of single crystal material, which includes the following steps:
S1, performing a coarse scan on a single crystal sample in a pole-figure mode to determine a rotation center of a single crystal sample signal;
S2, performing a fine scan at the rotation center to obtain a three-dimensional neutron diffraction signal;
S3, decomposing the three-dimensional neutron diffraction signal to obtain a diffraction peak curve and a rocking curve plane;
S4, correcting coordinates of the rocking curve plane;
S5, decomposing a corrected rocking curve plane to obtain a rocking curve; and
S6, quantitatively analyzing a lattice constant and orientation distribution information in the three-dimensional neutron diffraction signal according to the diffraction peak curve and the rocking curve.

Preferably, the rotation center is a rotation position with a diffraction signal after pole figure coarse scan, and a rotation angle χ is capable of being adjusted, so as to enable the diffraction signal to be located in a center of a two-dimensional area detector, and coordinates of the center are taken as rotation center positions (χ, φ) of the single crystal sample signal.

Preferably, for the rotation angle χ, the three-dimensional neutron diffraction signal is expressed as follows:

$$I ( θ , η , φ ) , θ ∈ Θ , η ∈ H , φ ∈ ϕ ;$$

where, θ represents an included angle between a connecting line of a single pixel point and an optical center in a detector and an incident neutron/X-ray, and η represents an included angle between a connecting line of a single pixel point and a detector center and a positive direction of a Z-axis.

Preferably, decomposing the three-dimensional neutron diffraction signal into the diffraction peak curve and the rocking curve plane, respectively includes lattice constant and lattice orientation information, and includes following steps:
S3.1: obtaining the diffraction peak curve, and a formula is:

$$I ( θ ) = {\sum }_{η ∈ H} {\sum }_{φ ∈ ϕ} I ( θ , η , φ ) ;$$

S3.2: obtaining the rocking curve plane, and a formula is:

$$I ( η , φ ) = {\sum }_{θ ∈ Θ} I ( θ , η , φ ) .$$

Preferably, the S4 includes:
S4.1: calculating a directional coordinate N_{L} of a crystal plane after Euler ring rotation according to a reflection principle, and a formula is:

$$θ = \frac{π}{2} - arccos ( {N}_{L} \cdot {e}_{x} ) ;$$

where eₓ represents a unit vector of an x-axis;
S4.2: calculating a direction coordinate N of the crystal plane before rotation according to rotation angles χ, φ, as shown below:

$$N = inv ( [ \begin{matrix}cos φ & sin φ & 0 \\ - sin φ & cos φ & 0 \\ 0 & 0 & 1\end{matrix} ] ) inv ( [ \begin{matrix}1 & 0 & 0 \\ 0 & cos χ & sin χ \\ 0 & - sin χ & cos χ\end{matrix} ] ) ;$$

S4.3: solving a following equation according to Euler angle definition:

$$[ \begin{matrix}cos ω & sin ω & 0 \\ - sin ω & cos ω & 0 \\ 0 & 0 & 1\end{matrix} ] [ \begin{matrix}1 & 0 & 0 \\ 0 & cos χ & sin χ \\ 0 & - sin χ & cos χ\end{matrix} ] N = {N}_{L .}$$

Preferably, the S5 includes following steps:
S5.1: obtaining a rocking curve I(η), and a formula is as follows:

$$I ( η ) = {\sum }_{ω Ω} I ( η , ω ) ;$$

S5.2: obtaining a rocking curve I(ω), and a formula is as follows:

$$I ( ω ) = {\sum }_{η ∈ H} I ( η , ω ) .$$

Preferably, the S6 includes:
S6.1, fitting and analyzing the diffraction peak curve by using a Gaussian function, defining a peak position as θₕₖ₁, and according to a Bragg law:

$$2 {d}_{hk 1} sin {θ}_{hk 1} = λ ;$$

where, λ is an incident neutron wavelength, and a lattice constant dₕₖ₁ in a subgrain is capable of being solved;

S6.2, respectively calculating a full width at half maximum of the rocking curve I(η) and the rocking curve I(ω), so as to quantify an orientation distribution.

According to the disclosure, a processing system for three-dimensional neutron diffraction data of single crystal material is provided and includes:
module M1: configured for performing a coarse scan on a single crystal sample in a pole-figure mode to determine a rotation center of a single crystal sample signal;
module M2: configured for performing a fine scan at the rotation center to obtain a three-dimensional neutron diffraction signal;
module M3: configured for decomposing the three-dimensional neutron diffraction signal to obtain a diffraction peak curve and a rocking curve plane;
module M4: configured for correcting coordinates of the rocking curve plane;
module M5: configured for decomposing a corrected rocking curve plane to obtain a rocking curve; and
module M6: configured for quantitatively analyzing a lattice constant and orientation distribution information in the three-dimensional neutron diffraction signal according to the diffraction peak curve and the rocking curve.

Preferably, the rotation center is a rotation position with a diffraction signal after pole figure coarse scan, and a rotation angle χ is capable of being adjusted, so as to enable the diffraction signal to be located in a center of a two-dimensional area detector, and coordinates of the center are taken as rotation center positions (χ, φ) of the single crystal sample signal.

Preferably, for the rotation angle χ, the three-dimensional neutron diffraction signal is expressed as follows:

$$I ( θ , η , φ ) , θ ∈ Θ , η ∈ H , φ ∈ ϕ ;$$

where, θ represents an included angle between a connecting line of a single pixel point and an optical center in a detector and an incident neutron/X-ray, and η represents an included angle between a connecting line of a single pixel point and a detector center and a positive direction of a Z-axis.

Compared with the prior art, the disclosure has the following beneficial effects.

Firstly, on that basis of determining the single crystal diffraction signal by pole figure coarse scan, the disclosure continuously rotates the rotation angle φ by fixing the rotation angle χ of the Euler ring, and effectively superimpose the data collected by a single two-dimensional area detector, thus the problem of testing and collecting the three-dimensional neutron diffraction signal of a single crystal sample is realized and a complete three-dimensional diffraction signal is obtained.

Secondly, the disclosure decomposes the three-dimensional neutron diffraction signal into a diffraction peak curve and a rocking curve plane, and then decomposes the rocking curve plane into two vertical rocking curves after coordinate correction according to the Euler angle definition, thus the synchronous test and extraction of lattice spacing and two-way orientation distribution of single crystal samples are solved.

Thirdly, the disclosure may nondestructively characterize the internal microstructure of the single crystal material, provide accurate data support for studying the lattice strain distribution and orientation characteristic, and further may synchronously characterize and analyze the lattice spacing and orientation distribution information.

### BRIEF DESCRIPTION OF THE DRAWINGS

Other features, objects and advantages of the disclosure will become more apparent by reading the detailed description of non-limiting embodiments with reference to the following drawings:

FIG. 1 is a schematic diagram of a three-dimensional neutron diffraction experiment;

FIG. 2 is a schematic flow chart of the working method of the disclosure;

FIGS. 3A-3C are three-dimensional neutron diffraction data and decomposition results thereof, where FIG. 3A is a three-dimensional neutron diffraction signal, FIG. 3B is a diffraction peak curve, and FIG. 3C is a rocking curve plane; and

FIGS. 4A-4B are effect diagrams of the rocking curve plane before and after coordinate conversion, where, FIG. 4A is the effect diagram before conversion, and FIG. 4B is the effect diagram after conversion.

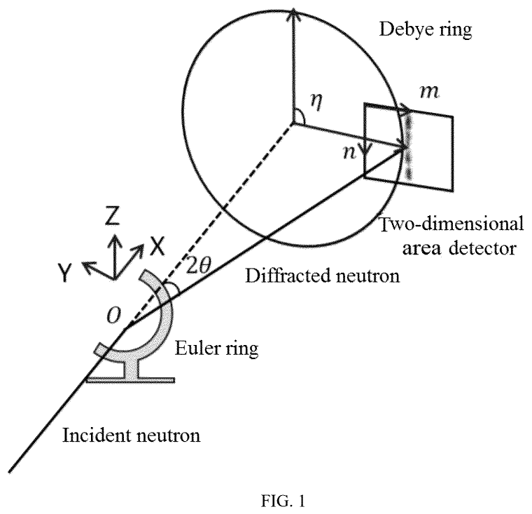

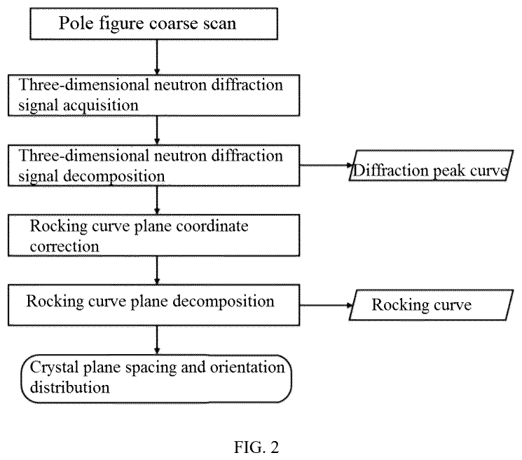

### DETAILED DESCRIPTION OF THE EMBODIMENTS

The disclosure will be described in detail with reference to specific embodiments. The following embodiments will help those skilled in the art to further understand the disclosure, but may not limit the disclosure in any way. It should be pointed out that those skilled in the art may make several changes and improvements without departing from the concept of the disclosure. These are all within the scope of protection of the disclosure.

By fixing the rotation angle χ of the Euler ring and continuously rotating the rotation angle φ, the high-precision acquisition of the three-dimensional diffraction signal of the single crystal sample is realized. The obtained three-dimensional diffraction signal is decomposed into diffraction peak curve and rocking curve plane, and the coordinate of rocking curve plane is corrected based on a neutron diffraction geometric model. Finally, through the comprehensive analysis of diffraction peak curve and rocking curve plane, the lattice spacing and lattice orientation distribution information of single crystal materials are quantitatively extracted, and the internal microstructure characteristics of single crystal materials are accurately characterized.

The laboratory coordinate system and the rotation coordinate system defined in the disclosure are (x,y,z), and (ω, χ, φ), respectively. The two-dimensional neutron diffraction signal coordinates are represented by two N₁×N₂ matrices, which are denoted as Θ and H. Specifically, the origin of the laboratory coordinate system is the optical center of the experiment, the positive direction of the X-axis coincides with the direction of the incident neutron/X-ray, the direction of the Z-axis is vertically upward, and the direction of the Y-axis is determined according to the right-hand rule. In the way of Euler angle definition, the rotation coordinate system (ω, χ, φ) is specified, thus the three-dimensional rotation coordinate of Euler ring in space is defined. The single diffraction signal is collected by a two-dimensional area detector, which has N₁×N₂ pixel points. According to the neutron diffraction geometry, the orientation information (θ, η) of each pixel point in the two-dimensional area detector is calculated, that is, the included angle θ between the connecting line between a single pixel point and the optical center in the detector and the incident neutron/X-ray, and the included angle n between the connecting line between a single pixel point and the detector center and the positive direction of the Z axis, where clockwise is defined as the positive direction. Then the coordinates of the two-dimensional neutron diffraction signal, that is, the two-dimensional orientation information, may be expressed by two N₁×N₂ matrices, and are denoted as Θ and H.

### Embodiment 1

A processing method for three-dimensional neutron diffraction data of single crystal material is provided, and includes the following steps.
S1, a coarse scan is performed on a single crystal sample in a pole-figure mode to determine a rotation center of a single crystal sample signal. The neutron diffraction signal of single crystal sample is speckled in space, so it is necessary to rotate Euler ring to search for the specific rotation angle corresponding to the speckled. The rotation angle X is gradually increase from 0° to 90° in steps of 10°, and for each step of that rotation angle X, the rotation angle φ is gradually increase from 0° to 360° in steps of 5°. After the pole figure coarse scan, the rotation angle X may be adjusted at the rotation position with diffraction signal, so that the diffraction signal is located in the center of the two-dimensional area detector, and this coordinate is taken as the rotation center position (χ, φ) of the single crystal sample signal.
S2, a fine scan is performed at the rotation center to obtain a three-dimensional neutron diffraction signal. The fine scan is performed at the rotation center positions (χ, φ), the rotation angle χ is fixed, and fine scan is performed in step Δφ within the range of plus or minus 5° of the rotation angle φ. Where the step Δφ is determined within the range of 0.1°-0.25° according to the sample and the specific requirements of the experiment, and the set of all rotation angles φ is specified as φ. Then for a specific rotation angle X, the three-dimensional neutron diffraction signal, that is, the signal intensity of each pixel point on the two-dimensional area detector, may be expressed as:

$$I ( θ , η , φ ) , θ ∈ Θ , η ∈ H , φ ∈ ϕ .$$

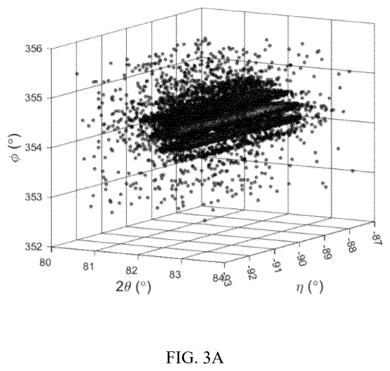

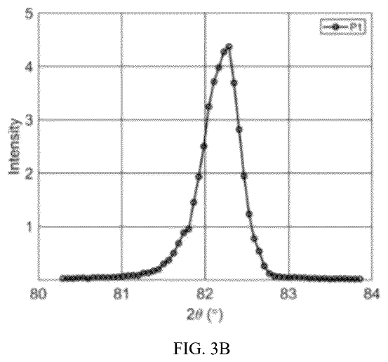

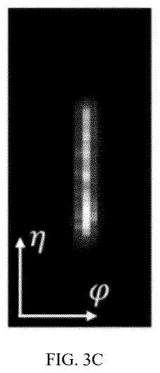

S3, the three-dimensional neutron diffraction signal is decomposed to obtain a diffraction peak curve and a rocking curve plane. The decomposing the three-dimensional neutron diffraction signal into the diffraction peak curve and the rocking curve plane, respectively includes lattice constant and lattice orientation information. As shown in FIG. 3A, the S3 includes the following steps:
S3.1: the diffraction peak curve is obtained, and a formula is:

$$I ( θ ) = {\sum }_{η ∈ H} {\sum }_{φ ∈ ϕ} I ( θ , η , φ ) ;$$

S3.2: the rocking curve plane is obtained, and a formula is:

$$I ( η , φ ) = {\sum }_{θ ∈ Θ} I ( θ , η , φ ) .$$

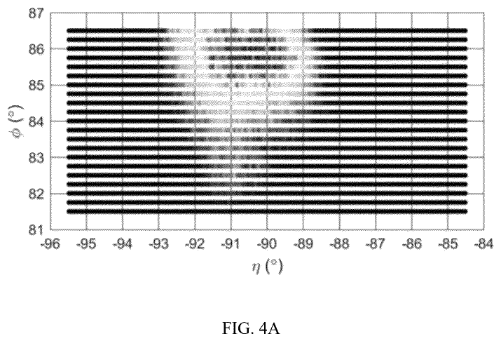

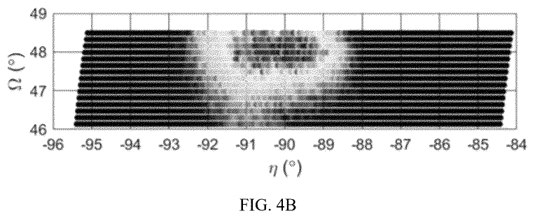

S4, coordinates of the rocking curve plane are corrected. According to the definition of Euler angle, the rotation angle X is not perpendicular to φ, so it is necessary to convert the rocking curve plane I(η, φ) into I(η, ω), where the set φ is converted into Ω. The effect diagram before and after the conversion is shown in FIGS. 4A-4B, and the step S4 includes the following steps:
S4.1: a directional coordinate N_{L} of a crystal plane after Euler ring rotation is calculated according to a reflection principle, assuming that eₓ represents a unit vector of an x-axis, then

$$θ = \frac{π}{2} - arccos ( {N}_{L} \cdot {e}_{x} ) ;$$

S4.2: a direction coordinate N of the crystal plane before rotation is calculated according to rotation angles χ, φ, as shown below:

$$N = inv ( [ \begin{matrix}cos φ & sin φ & 0 \\ - sin φ & cos φ & 0 \\ 0 & 0 & 1\end{matrix} ] ) inv ( [ \begin{matrix}1 & 0 & 0 \\ 0 & cos χ & sin χ \\ 0 & - sin χ & cos χ\end{matrix} ] ) ;$$

S4.3: a following equation is solved according to Euler angle definition:

$$[ \begin{matrix}cos ω & sin ω & 0 \\ - sin ω & cos ω & 0 \\ 0 & 0 & 1\end{matrix} ] [ \begin{matrix}1 & 0 & 0 \\ 0 & cos χ & sin χ \\ 0 & - sin χ & cos χ\end{matrix} ] N = {N}_{L .}$$

S5, a corrected rocking curve plane is decomposed to obtain a rocking curve. As shown in FIG. 3C, the converted rocking curve plane I(η, ω) is decomposed into two rocking curves I(η) and I(ω) in the vertical direction. The S5 includes the following steps:
S5.1: a rocking curve I(η) is obtained, and a formula is as follows:

$$I ( η ) = {\sum }_{ω ∈ Ω} I ( η , ω ) ;$$

S5.2: a rocking curve I(ω) is obtained, and a formula is as follows:

$$I ( ω ) = {\sum }_{η ∈ H} I ( η , ω ) .$$

S6, a lattice constant and orientation distribution information in the three-dimensional neutron diffraction signal are quantitatively analyzed according to the diffraction peak curve and the rocking curve. The S6 includes:
S6.1, the lattice constant is calculated, the diffraction peak curve is fitted and analyzed by using a Gaussian function, as shown in FIG. 3B, a peak position as θₙₖ₁ is defined, and according to a Bragg law 2dₕₖ₁ sin θₕₖ₁=λ, where λ is an incident neutron wavelength, and a lattice constant in a subgrain is capable of being solved;
S6.2, orientation distribution information is calculated, a full width at half maximum of I(η) and I(ω) are respectively calculated, so as to quantify an orientation distribution.

The disclosure aims to achieve high-precision synchronous measurement of lattice spacing and lattice orientation distribution of single crystal materials, which is applied to neutron three-dimensional diffraction experiments of single crystal materials and subsequent data analysis. Based on the high-precision three-dimensional rotation of the Euler ring, the disclosure carries out multi-angle three-dimensional neutron diffraction data acquisition on a single crystal sample to obtain a complete three-dimensional diffraction signal, and then decomposes the collected three-dimensional diffraction signal into a diffraction peak curve and a rocking curve plane, and decomposes the crystal structure information into lattice spacing information and orientation information, thereby effectively realizing the microscopic characterization of the internal structure of a single crystal material and providing accurate data support for studying lattice strain distribution and orientation characteristics.

### Embodiment 2

The disclosure also provides a processing system for three-dimensional neutron diffraction data of single crystal material, which may be realized by executing the flow steps of the processing method for three-dimensional neutron diffraction data of single crystal material, that is, those skilled in the art may understand three-dimensional neutron diffraction data processing method for the single crystal material as a preferred embodiment of the processing system for three-dimensional neutron diffraction data of single crystal material.

The processing system for three-dimensional neutron diffraction data of single crystal material is provided, and includes the following modules.
Module M1: configured for performing a coarse scan on a single crystal sample in a pole-figure mode to determine a rotation center of a single crystal sample signal. Where, the rotation center is a rotation position with a diffraction signal after pole figure coarse scan, and a rotation angle χ is capable of being adjusted, so as to enable the diffraction signal to be located in a center of a two-dimensional area detector, and coordinates of the center are taken as rotation center positions (χ, φ) of the single crystal sample signal.
Module M2: configured for performing a fine scan at the rotation center to obtain a three-dimensional neutron diffraction signal. Where, for the rotation angle χ, the three-dimensional neutron diffraction signal is expressed as follows: I(θ, η, φ), θ∈Θ, η∈H, φ∈φ; where, θ represents an included angle between a connecting line of a single pixel point and an optical center in a detector and an incident neutron/X-ray, and η represents an included angle between a connecting line of a single pixel point and a detector center and a positive direction of a Z-axis.
Module M3: configured for decomposing the three-dimensional neutron diffraction signal to obtain a diffraction peak curve and a rocking curve plane, where decomposing the three-dimensional neutron diffraction signal into the diffraction peak curve and the rocking curve plane, respectively includes lattice constant and lattice orientation information, and includes following modules: module M3.1: the diffraction peak curve is obtained, and a formula is I(θ)=Σ_{η∈H}Σ_{φ∈φ}I(θ, η, φ); module M3.2: the rocking curve plane is obtained, and a formula is I(η, φ)=Σ_{θ∈Θ}I(θ, η, φ).
Module M4: configured for correcting coordinates of the rocking curve plane. Where, the module M4 includes: module M4.1: a directional coordinate N_{L} of a crystal plane after Euler ring rotation is calculated according to a reflection principle, and a formula is:

$$θ = \frac{π}{2} - arccos ( {N}_{L} \cdot {e}_{x} ) ;$$

where eₓ represents a unit vector of an x-axis; module M4.2: a direction coordinate N of the crystal plane before rotation is calculated according to rotation angles χ, φ, as shown below:

$$N = inv ( [ \begin{matrix}cos φ & sin φ & 0 \\ - sin φ & cos φ & 0 \\ 0 & 0 & 1\end{matrix} ] ) inv ( [ \begin{matrix}1 & 0 & 0 \\ 0 & cos χ & sin χ \\ 0 & - sin χ & cos χ\end{matrix} ] ) ;$$

module M4.3: a following equation is solved according to Euler angle definition:

$$[ \begin{matrix}cos ω & sin ω & 0 \\ - sin ω & cos ω & 0 \\ 0 & 0 & 1\end{matrix} ] [ \begin{matrix}1 & 0 & 0 \\ 0 & cos χ & sin χ \\ 0 & - sin χ & cos χ\end{matrix} ] N = {N}_{L} .$$

Module M5: configured for decomposing a corrected rocking curve plane to obtain a rocking curve. Where, the module M5 includes following modules: module M5.1: a rocking curve I(η) is obtained, and a formula is as follows: I(η)=Σ_{ω□Ω}I(η, ω); module M5.2: a rocking curve I(ω) is obtained, and a formula is as follows: I(ω)=Σ_{η∈H}I(η, ω).

Module M6: configured for quantitatively analyzing a lattice constant and orientation distribution information in the three-dimensional neutron diffraction signal according to the diffraction peak curve and the rocking curve. Where, the module M6 includes: module M6.1, the diffraction peak curve is fitted and analyzed by using a Gaussian function, a peak position as θₕₖ₁ is defined, and according to a Bragg law: 2dₕₖ₁ sin θₕₖ₁=λ, where, λ is an incident neutron wavelength, and a lattice constant dₕₖ₁ in a subgrain is capable of being solved; module M6.2, a full width at half maximum of the rocking curve I(η) and the rocking curve I(ω) are respectively calculated, so as to quantify an orientation distribution.

Those skilled in the art know that in addition to realizing the system provide by the disclosure and various devices, modules and units thereof in the form of pure computer-readable program code, the system and devices, modules and units provided by the disclosure may completely realize the same functions in the form of logic gates, switches, application specific integrated circuits, programmable logic controllers and embedded microcontrollers by logically programming the method steps. Therefore, the system provided by the disclosure and devices, modules and units may be regarded as a hardware component, and the devices, modules and units for realizing various functions included in system may also be regarded as structures in the hardware component; Devices, modules and units for realizing various functions may also be regarded as both software modules for realizing methods and structures in hardware components.

The specific embodiments of the disclosure have been described above. It should be understood that the disclosure is not limited to the above specific embodiments, and those skilled in the art may make various changes or modifications within the scope of the claims, which may not affect the essence of the disclosure. In case of no conflict, the embodiments of the disclosure and the features in the embodiments may be arbitrarily combined with each other.

What is claimed is:

1. A processing method for three-dimensional neutron diffraction data of single crystal material, comprising:
S1, performing a coarse scan on a single crystal sample in a pole-figure mode to determine a rotation center of a single crystal sample signal;
S2, performing a fine scan at the rotation center to obtain a three-dimensional neutron diffraction signal;
S3, decomposing the three-dimensional neutron diffraction signal to obtain a diffraction peak curve and a rocking curve plane;
S4, correcting coordinates of the rocking curve plane;
S5, decomposing a corrected rocking curve plane to obtain a rocking curve; and
S6, quantitatively analyzing a lattice constant and orientation distribution information in the three-dimensional neutron diffraction signal according to the diffraction peak curve and the rocking curve.

2. The processing method for three-dimensional neutron diffraction data of single crystal material according to claim 1, wherein the rotation center is a rotation position with a diffraction signal after pole figure coarse scan, and a rotation angle χ is capable of being adjusted, so as to enable the diffraction signal to be located in a center of a two-dimensional area detector, and coordinates of the center are taken as rotation center positions (χ, φ) of the single crystal sample signal.

3. The processing method for three-dimensional neutron diffraction data of single crystal material according to claim 2, wherein, for the rotation angle χ, the three-dimensional neutron diffraction signal is expressed as follows:
$$I ( θ , η , p ) , θ ∈ Θ , η ∈ H , φ ∈ ϕ ;$$
wherein, θ represents an included angle between a connecting line of a single pixel point and an optical center in a detector and an incident neutron/X-ray, and η represents an included angle between a connecting line of a single pixel point and a detector center and a positive direction of a Z-axis.

4. The processing method for three-dimensional neutron diffraction data of single crystal material according to claim 3, wherein decomposing the three-dimensional neutron diffraction signal into the diffraction peak curve and the rocking curve plane, respectively comprises lattice constant and lattice orientation information, and comprises following steps:
S3.1: obtaining the diffraction peak curve, and a formula is:
$$I ( θ ) = {\sum }_{η ∈ H} {\sum }_{φ ∈ ϕ} I ( θ , η , φ ) ;$$
and
S3.2: obtaining the rocking curve plane, and a formula is:
$$I ( η , φ ) = {\sum }_{θ ∈ Θ} I ( θ , η , φ ) .$$

5. The processing method for three-dimensional neutron diffraction data of single crystal material according to claim 4, wherein the S4 comprises:
S4.1: calculating a directional coordinate N_{L} of a crystal plane after Euler ring rotation according to a reflection principle, and a formula is:
$$θ = \frac{π}{2} - arccos ( {N}_{L} \cdot {e}_{x} ) ;$$
wherein eₓ represents a unit vector of an x-axis;
S4.2: calculating a direction coordinate N of the crystal plane before rotation according to rotation angles χ, φ, as shown below:
$$N = inv ( [ \begin{matrix}cos φ & sin φ & 0 \\ - sin φ & cos φ & 0 \\ 0 & 0 & 1\end{matrix} ] ) inv ( [ \begin{matrix}1 & 0 & 0 \\ 0 & cos χ & sin χ \\ 0 & - sin χ & cos χ\end{matrix} ] ) ;$$
and
S4.3: solving a following equation according to Euler angle definition:
$$[ \begin{matrix}cos ω & sin ω & 0 \\ - sin ω & cos ω & 0 \\ 0 & 0 & 1\end{matrix} ] [ \begin{matrix}1 & 0 & 0 \\ 0 & cos χ & sin χ \\ 0 & - sin χ & cos χ\end{matrix} ] N = {N}_{L} .$$

6. The processing method for three-dimensional neutron diffraction data of single crystal material according to claim 5, wherein the S5 comprises following steps:
S5.1: obtaining a rocking curve I(η), and a formula is as follows:
$$I ( η ) = {\sum }_{ω ∈ Ω} I ( η , ω ) ;$$
and
S5.2: obtaining a rocking curve I(ω), and a formula is as follows:
$$I ( ω ) = {\sum }_{η ∈ H} I ( η , ω ) .$$

7. The processing method for three-dimensional neutron diffraction data of single crystal material according to claim 6, wherein the S6 comprises:
S6.1, fitting and analyzing the diffraction peak curve by using a Gaussian function, defining a peak position as θₕₖ₁, and according to a Bragg law:
$$2 {d}_{h k 1} sin {θ}_{h k 1} = λ ;$$
wherein, λ is an incident neutron wavelength, and a lattice constant dₕₖ₁ in a subgrain is capable of being solved; and
S6.2, respectively calculating a full width at half maximum of the rocking curve I(η) and the rocking curve I(ω), so as to quantify an orientation distribution.

8. A processing system for three-dimensional neutron diffraction data of single crystal material, comprising:
module M1: configured for performing a coarse scan on a single crystal sample in a pole-figure mode to determine a rotation center of a single crystal sample signal;
module M2: configured for performing a fine scan at the rotation center to obtain a three-dimensional neutron diffraction signal;
module M3: configured for decomposing the three-dimensional neutron diffraction signal to obtain a diffraction peak curve and a rocking curve plane;
module M4: configured for correcting coordinates of the rocking curve plane;
module M5: configured for decomposing a corrected rocking curve plane to obtain a rocking curve; and
module M6: configured for quantitatively analyzing a lattice constant and orientation distribution information in the three-dimensional neutron diffraction signal according to the diffraction peak curve and the rocking curve.

9. The processing system for three-dimensional neutron diffraction data of single crystal material according to claim 8, wherein the rotation center is a rotation position with a diffraction signal after pole figure coarse scan, and a rotation angle χ is capable of being adjusted, so as to enable the diffraction signal to be located in a center of a two-dimensional area detector, and coordinates of the center are taken as rotation center positions (χ, φ) of the single crystal sample signal.

10. The processing system for three-dimensional neutron diffraction data of single crystal material according to claim 8, wherein for the rotation angle χ, the three-dimensional neutron diffraction signal is expressed as follows:
$$I ( θ , η , p ) , θ ∈ Θ , η ∈ H , φ ∈ ϕ ;$$
wherein, θ represents an included angle between a connecting line of a single pixel point and an optical center in a detector and an incident neutron/X-ray, and η represents an included angle between a connecting line of a single pixel point and a detector center and a positive direction of a Z-axis.
